(19) United States
(12) Patent Application Publication
(10) Pub. No.: US 2008/0143465 A1
(43) Pub. Date: Jun. 19, 2008

(54) Insulation system and method for a transformer

(75) Inventors: Qi Tan, Rexford, NY (US); Patricia Chapman Irwin, Altamont, NY (US); Yang Cao, Niskayuna, NY (US); Abdelkrim Younsi, Ballston Lake, NY (US)

Correspondence Address: GENERAL ELECTRIC COMPANY (PCPI);C/O FLETCHER YODER, P. O. BOX 692289, HOUSTON, TX, 77269-2289, US

(73) Assignee: General Electric Company

(21) Appl. No.: 11/639,725

(22) Filed: Dec. 15, 2006

(51) Int. Cl. H01F 30/12; H01F 27/32; H01F 41/12

(52) U.S. Cl. 336/5; 336/206; 29/602.1

(57) ABSTRACT

A transformer including a magnetic core is provided. The magnetic core includes multiple laminate stacks having at least one opening. The transformer also includes a winding comprising a conductive material around the magnetic core through the at least one opening and surrounded by an insulating layer having a dielectric constant that varies as a function of voltage.

### BACKGROUND

The invention relates generally to insulating systems for electrical machines and machine windings, and more specifically to an insulation system having non-linear dielectric properties.

Electrical machines and devices such as generators, motors, actuators, transformers, etc. are constantly subjected to various electrical, mechanical, thermal, and environmental stresses. Such stresses tend to degrade them, consequently reducing their lives. In an example, a static magnetic field is retained after power is disconnected in a steel core in transformers due to magnetic remanence. When power is further reapplied, residual field causes a high inrush current until effect of the magnetic remanence is reduced, usually after a few cycles of applied alternating current. Overcurrent protection devices such as fuses in transformers connected to long overhead power transmission lines are unable to protect the transformers from induced currents due to geomagnetic disturbances during solar storms that may cause saturation of the steel core, and false operation of transformer protection devices. It has been commonly observed that deterioration of insulation in the foregoing devices is a dominant factor in their failures.

Insulation systems for electrical machines such as generators, motors and transformers have been under constant development to improve performance of the machines. Materials generally used in electrical insulation include polyimide film, epoxy-glass fiber composite and mica tape. Insulating materials generally need to have the mechanical and physical properties that can withstand various electrical rigors of the electrical machines such as lightning and switching surges. In addition, some of the desirable properties of an insulation system include withstanding extreme operating temperature variations, and a long design life.

The aforementioned insulating materials have an essentially constant dielectric constant, which protects them from electrical conduction based on their respective composite breakdown strengths. However, certain factors such as operating temperatures, environment, voltage stresses, thermal cycling and voltage surges from lightning and switching deteriorate the insulating materials over a long period of time thus reducing their useful or operational life.

Therefore, it would be desirable to provide an insulation system that would address the aforementioned problems and meet the current demands of industry applications.

### BRIEF DESCRIPTION

In accordance with one aspect of the invention, a transformer is provided. The transformer includes a magnetic core comprising a plurality of laminated stacks having at least one opening. The transformer also includes a winding comprising a conductive material around the magnetic core through the at least one opening and surrounded by an insulating layer having a dielectric constant that varies as a function of voltage.

In accordance with another aspect of the invention, a method for forming an insulation system in a transformer is provided. The method includes disposing an insulating layer around at least a portion of a winding, the insulating layer having a dielectric constant that varies as a function of voltage.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of a transformer including a magnetic core with windings employing a non-linear or varying dielectric material as insulation in accordance with the invention;

FIG. 2 is a vertical sectional view of the transformer in FIG. 1 illustrating multiple turns in the windings;

FIG. 3 is a cross-sectional view of a non-linear dielectric insulation system employed in FIG. 2 in accordance with the invention;

FIG. 4 is a schematic illustration of a corner of the winding of FIG. 2 experiencing electrical stress;

FIG. 5 is a graphical comparison of dielectric constant as a function of electric field intensity of polyvinylidene fluoride film without and with fillers, all of which may be used in an electrical machine and with windings in accordance with the invention; and

FIG. 6 is a graphical illustration of electric field strength around the corner in FIG. 4.

### DETAILED DESCRIPTION

As discussed in detail below, embodiments of the present invention include an insulation system using non-linear or varying dielectric property materials. As used herein, the term “non-linear” refers to a non-uniform change in dielectric constant with voltage. The insulation system disclosed herein may be employed in machines operating at high voltages such as, but not limited to, transformers. The insulation system includes an inherent adaptive property such that the dielectric constant of the non-linear dielectric may increase at locations in the machine insulation experiencing high electrical stress and provide desirable electrical protection to the machine. The electrical protection is obtained through electrical stress smoothing and reduction in the local electric field intensity.

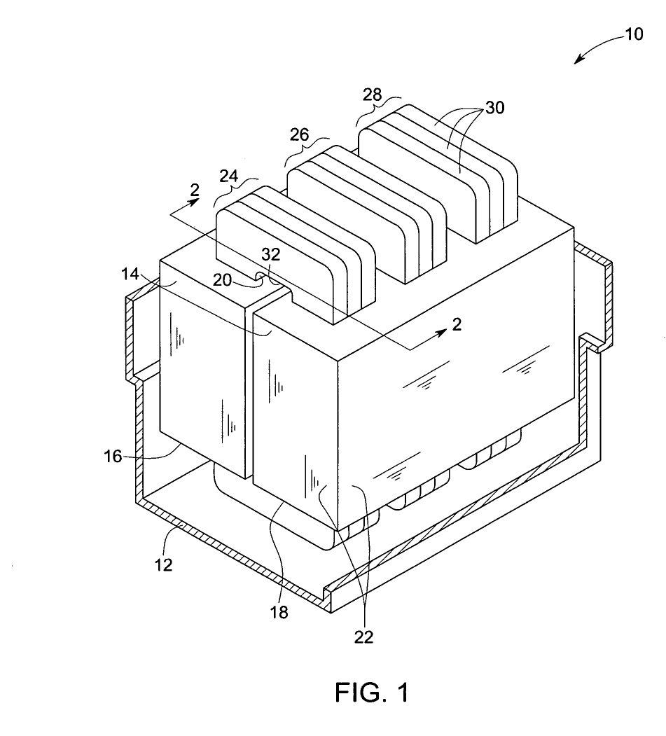

Turning now to the drawings, FIG. 1 is a perspective view of a transformer 10 including a tank 12. The transformer 10, in the illustrated embodiment, is a three phase shell-core transformer. In another embodiment, the transformer 10 may be a single phase transformer. The transformer 10 includes a magnetic core 14 having a first core section 16 and a second core section 18 having at least one opening 20 and disposed adjacent to each other. In a particular embodiment, the first core section 16 and the second core section 18 may include three openings 20 each. The first core section 16 and the second core section 18 may also include multiple superposed laminated stacks 22. In a particular embodiment, the laminated stacks 22 may include laminated stacks made of a metal such as, but not limited to, steel. The transformer 10 may further include electrical winding phases 24, 26 and 28. Each of the electrical winding phases 24, 26 and 28 may include multiple windings 30 that are insulated by a non-linear dielectric layer (not shown) and stacked adjacent to each other. The windings 30 may surround the first core section 16 and the second core section 18 through openings 32 and the opening 20.

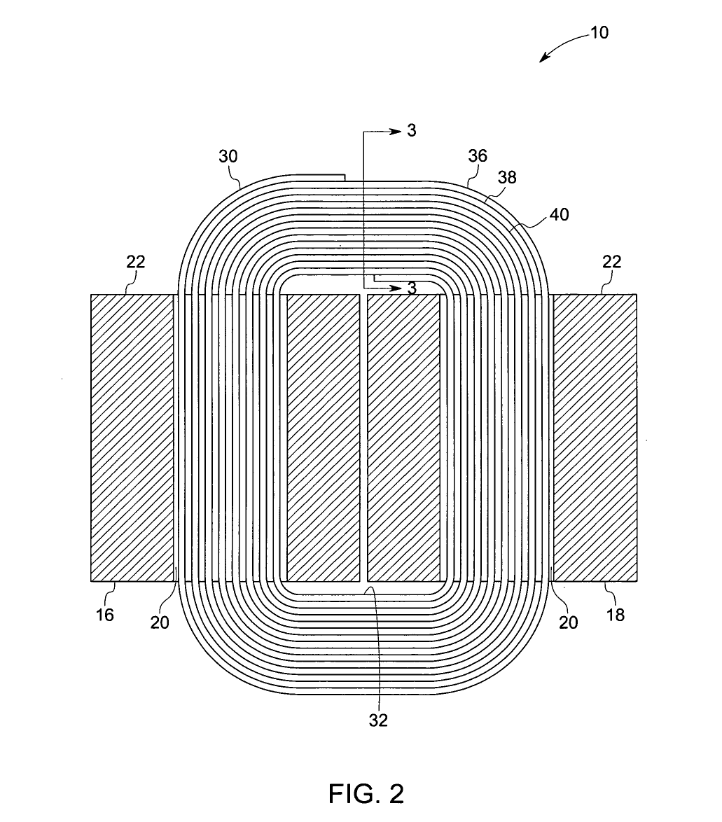

FIG. 2 is a vertical sectional view of the transformer 10 in FIG. 1 illustrating the windings 30. The windings 30 may include a conductive material that is wound spirally to form multiple turns 36, 38 and 40. In a particular embodiment, the conductive wire used is generally a magnet wire. Magnet wire is a copper wire with a coating of varnish or some other synthetic coating. In a non-limiting example, the number of turns may vary in the range between about a few to about thousands depending upon the power and application.

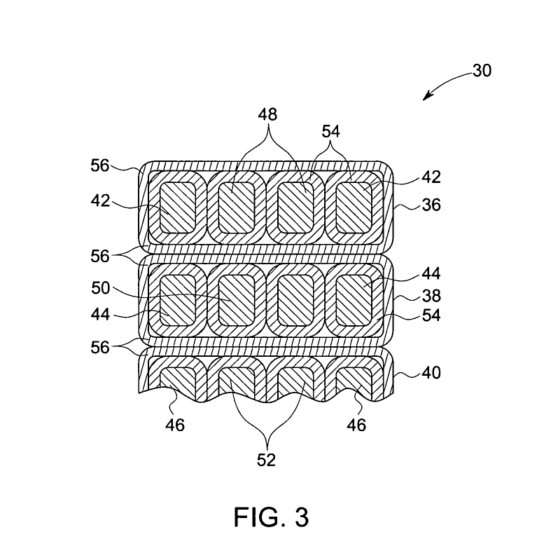

FIG. 3 is a cross-sectional view of the winding 30 in FIG. 2. Each of the turns 36, 38 and 40, as referenced in FIG. 2, include outer strands 42, 44 and 46 respectively. Similarly, the turns 36, 38 and 40 include inner strands 48, 50 and 52 respectively. The strands 42 and 48 are disposed in a row of strands in each turn 36 so that multiple turns 36, 38 and 40 may be disposed in a parallel arrangement. A non-linear dielectric insulation layer 54 may be applied around each of the outer strands 42, 44 and 46. Similarly, the non-linear dielectric insulation layer 54 may be applied around each of the inner strands 48, 50 and 52. Further, a non-linear dielectric insulation layer 56 may be applied between the turns 36, 38 and 40. In a presently contemplated embodiment, the dielectric constant of the non-linear dielectric insulation layers 54 and 56 increases with voltage or a local electric field.

In a particular embodiment, the non-linear dielectric insulation may include a mixed composite of a glass cloth, an epoxy binder, mica paper and a filler of size ranging from at least about 5 nm. Some non-limiting examples of the filler may include a micron filler and a nano filler. As noted above, such fillers may include lead zirconate, lead hafnate, lead zirconate titanate, lanthanum-doped lead zirconate stannate titanate, sodium niobate, barium titanate, strontium titanate, barium strontium titanate and lead magnesium niobate. In another example, the non-linear dielectric insulation may include polyetherimide, polyethylene, polyester, polypropylene, polytetrafluoroethylene, polyvinylidene fluoride, and polyvinylidene fluoride coploymers. Some non-limiting examples of mica may include muscovite, phlogopite, anandite, annite, biotite and bityte. The glass cloth may have varying amounts of woven density. Some non-limiting examples of the glass cloth are listed below in Table 1.

TABLE 1

| | | Count | Yarns | Weight | | Thickness | | Strength | |
|---|---|---|---|---|---|---|---|---|---|
| Style | Weave | Warp | Fill | oz/yd\hat{ }2 | g/m\hat{ }2 | mils | mm | Warp lbf/in | Fill lbf/in |
| 1076 | Plain | 60 | 25 | 0.96 | 33 | 1.8 | 0.05 | 120 | 20 |
| 1070 | Plain | 60 | 35 | 1.05 | 36 | 2 | 0.05 | 100 | 25 |
| 6060 | Plain | 60 | 60 | 1.19 | 40 | 1.9 | 0.05 | 75 | 75 |
| 1080 | Plain | 60 | 47 | 1.41 | 48 | 2.2 | 0.06 | 120 | 90 |
| 108 | Plain | 60 | 47 | 1.43 | 48 | 2.5 | 0.06 | 80 | 70 |
| 1609 | Plain | 32 | 10 | 1.48 | 50 | 2.6 | 0.07 | 160 | 15 |
| 1280/1086 MS | Plain | 60 | 60 | 1.59 | 54 | 2.1 | 0.05 | 120 | 120 |

Glass cloth of various woven densities, weights, thicknesses and strengths have been listed. A first example of the glass cloth is of a1076 glass type with a plain weave having a warp count of 60 and a weight of 33 g/m². Similarly, other examples include 1070, 6060, 1080, 108, 1609, and 1280 glass types. Glass acts as a mechanical support for the insulation system and also adds inorganic content to the composite that improves the thermal conductivity of the final composite system. The mica acts as the primary insulation for the composite. The epoxy binder is the only organic portion of the composite insulation system and acts as the glue to hold the system together. Further, the nonlinear filler provides the nonlinear response to the insulation system as well as improving the thermal conductivity of the composite. An electrical field stress may be experienced at edges of the outer strands 42, 44 and 46 and the inner strands 48, 50 and 52. There is also a high degree of electrical field stress measured at corners of the turns 36, 38 and 40 during transformer operation. The non-linear dielectric insulation layers 54 and 56 enable a more uniform distribution of electrical field and alleviate regions experiencing high electrical stress.

There are several ways to incorporate a filler into an insulation composite. Some non-limiting examples include extrusion of the filler and polymer forming a filled polymer system, solvent dispersion of the filler and polymer with subsequent evaporation of the solvent forming a film and using screen printing or dip coating techniques for incorporating the filler into the crossover points of the warp and weft fibers of the glass cloth. Furthermore, it has been found that silane treatment such as, but not limited to, 3-Glycidoxypropyl trimethoxysilane of the filler and the glass is important to desirable adhesion of the filler to the glass cloth and final composite structure. The choice of filler incorporation method depends on the final structure of the insulation composite. In an example, filled polymer films usually use extrusion, or solvent dispersion. In another embodiment, tapes of mica, glass cloth and epoxy resin usually use screen printing or dip coating on the glass cloth technique.

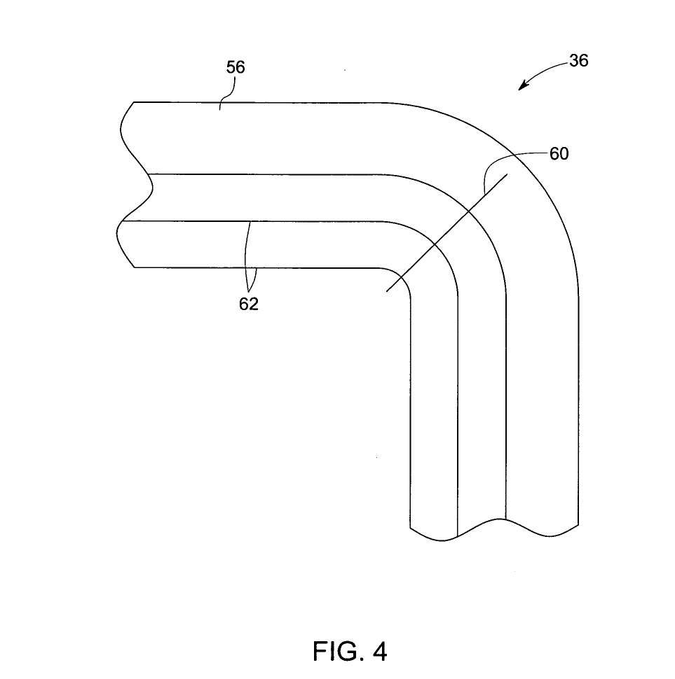

FIG. 4 is an exemplary schematic illustration of electrical field stress experienced at a corner 60 of the turn 36 in the winding 30 in FIG. 2. The corner 60 may include a non-linear dielectric insulation layer 56 as referenced in FIG. 3. The corner 60 is a region on the turn 36 that may undergo maximum electrical field stress during operation. It is desirable to reduce the electrical stress. A reduction in electrical stress may increase a voltage rating of the transformer. The non-linear dielectric insulation layer 56, as referenced in FIG. 3, distributes the electrical field uniformly at the corner 60 so as to minimize stress that has occurred due to an uneven distribution of the electrical field. As the electrical field stress increases at the corner 60, the non-linear dielectric layer 56 adapts accordingly so as to provide a more uniform electrical field distribution 62 around the corner 60 than would be present if conventional uniform dielectric strength materials were used, thus protecting the turn 36 from potential electrical damage.

In another illustrated embodiment of the invention, a method 70 of forming an insulation in a transformer may be provided. An insulating layer having a dielectric constant that varies as a function of voltage or electric field may be disposed around at least a portion of a winding in step 72. In a particular embodiment, the insulating layer may be disposed around a corner of the winding. In another embodiment, the insulating layer may be disposed between multiple strands in the winding. In another embodiment, the insulating layer may be made of mica, epoxy resin, glass cloth and as ceramic filler. In yet another embodiment, the glass cloth and the ceramic filler may be coated with silane. In a presently contemplated embodiment, the ceramic filler may be attached to the glass cloth via a technique of screen printing or dip coating.

### EXAMPLES

The examples that follow are merely illustrative and should not be construed to limit the scope of the claimed invention.

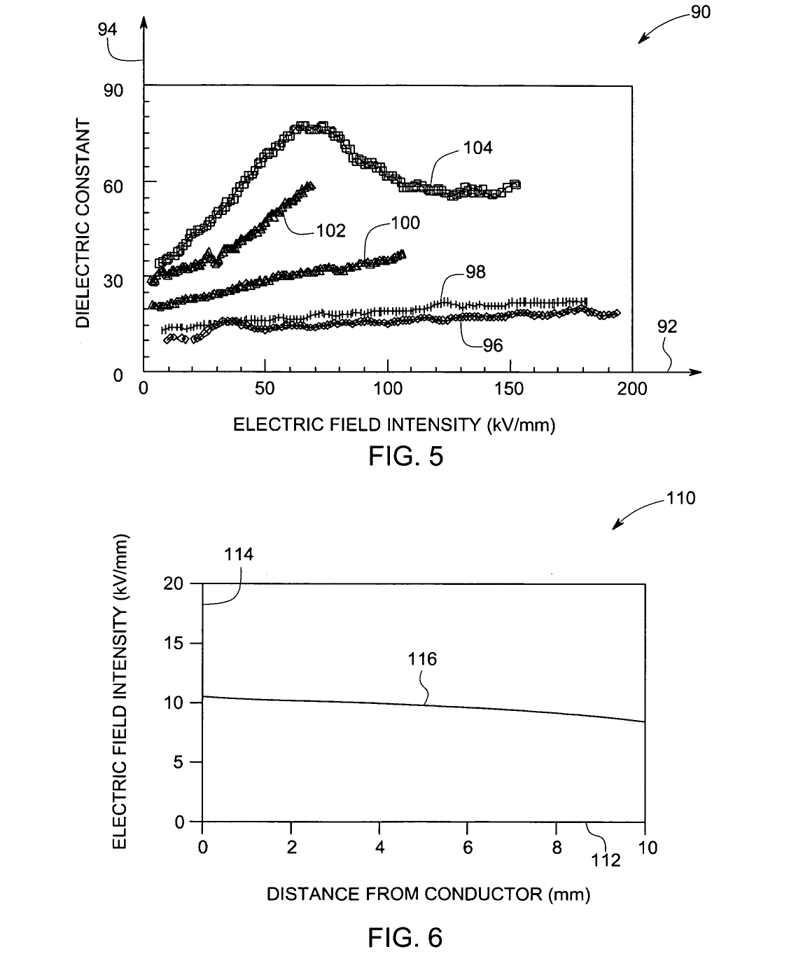

FIG. 5 is a graphical comparison 90 of dielectric constant as a function of electric field intensity for a polyvinylidene fluoride (PVDF) film without fillers and with fillers. The X-axis 92 represents electric field intensity in kV/mm. The Y-axis 94 represents dielectric constant of the PVDF film. Curve 96 represents dielectric constant of a PVDF film without a filler. As can be seen, the dielectric constant does not vary significantly as a function of the electric field intensity. Curve 98 represents dielectric constant of a PVDF film with 20% by volume of a micron lead zirconate filler. Similarly, curves 100, 102, and 104 represent dielectric constant as a function of electric field intensity for a PVDF film with 20% by volume of a nano lead zirconate filler, 40% by volume of a micron lead zirconate filler and 40% by volume of a nano lead zirconate filler respectively. As observed, the dielectric constant increases significantly from about 30 to peak at about 80 as a function of electric field intensity in the case of 40% by volume of a nano lead zirconate filler. Hence, addition of nanofillers in the PVDF film increases the variation of the dielectric constant with electrical field and enhances adaptability of an insulation system to fluctuations in electrical field stress.

FIG. 6 is a graphical illustration 110 of the electrical field profile at the corner 60 in FIG. 4 as a function of distance from a conductor such as turn 36 in FIG. 2 having a non-linear dielectric insulation layer. The X-axis 112 represents distance from the turn 36 through the non-linear dielectric insulation layer in mm. The Y-axis 114 represents electric field intensity in kilovolts/mm. As can be seen from curve 116, the electric field is stable at from 10 kV/mm with the distance from the turn 36. In electrostatics, product of the dielectric constant and electric field depends on potential difference and dielectric properties of a medium. If the dielectric constant were held constant, the local electric field on a surface adjacent to an electrically conducting element would be very high due to its relatively small area. The electric field would then decrease and reach a minimum at an outermost surface of the insulation that is at ground potential. However, if the dielectric constant were allowed to increase with the electric field, this compensating effect would force a uniformity across the entire material as shown. Thus, the non-linear dielectric insulation layer provides a generally uniform field distribution within the conductor eliminating or reducing the possibility of electrical damage to the conductor.

Beneficially, the above described insulation system and method are capable of suppressing ripple voltage and sudden current surges in transformers. Further, the suppression of transient voltages ensures a longer lifetime of operation for transformers. Usage of such insulation systems also helps in taking care of the aforementioned factors without a significant increase in size of the transformers.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A transformer comprising:
a magnetic core comprising a plurality of laminated stacks having at least one opening; and
a plurality of windings comprising a conductive material around the magnetic core through the at least one opening and surrounded by an insulating layer having a dielectric constant that varies as a function of voltage.

2. The transformer of claim 1, wherein the dielectric constant of the insulating layer increases with voltage.

3. The transformer of claim 1, wherein the insulating layer is disposed between the plurality of windings.

4. The transformer of claim 1, wherein the insulating layer is disposed between a plurality of strands in each of the plurality of windings.

5. The transformer of claim 1, wherein the insulating layer is disposed at a plurality of corners of each of the plurality of windings.

6. The transformer of claim 1, the insulating layer comprising polymer composites.

7. The transformer of claim 6, the polymer composites comprising polyetherimide, polycarbonate, polyethylene, polyester, polypropylene, epoxy, silicone, polytetrafluoroethylene, polyvinylidene fluoride, and polyvinylidene fluoride coploymers.

8. The transformer of claim 1, the insulating layer comprising at least one nanofiller.

9. The transformer of claim 8, the nanofiller comprising a ceramic filler of at least about 5 nm.

10. The transformer of claim 9, the ceramic filler comprising lead zirconate, lead hafnate, lead zirconate titanate, lanthanum-doped lead zirconate stannate titanate, sodium niobate, barium titanate, strontium titanate and barium strontium titanate.

11. The transformer of claim 1, wherein the plurality of laminated stacks comprise laminated stacks made of a metal.

12. A method of forming an insulation in a transformer comprising disposing an insulating layer around at least a portion of a winding, the insulating layer having a dielectric constant that varies as a function of voltage.

13. The method of claim 12, wherein disposing comprises disposing the insulating layer around a corner of the winding.

14. The method of claim 12, wherein disposing comprises disposing the insulating layer between a plurality of strands in the winding.

15. The method of claim 12, wherein disposing comprises disposing the insulating layer at a plurality of corners of the winding.

16. The method of claim 12, wherein disposing an insulating layer comprises disposing an insulating layer made of mica, epoxy resin, glass cloth and a ceramic filler.

17. The method of claim 17, wherein disposing comprises coating silane onto the glass cloth and the ceramic filler.

18. The method of claim 17, wherein disposing comprises attaching the ceramic filler to the glass cloth.

19. The method of claim 19, wherein attaching comprises attaching via screen printing or dip coating.

20. A three-phase transformer comprising:
a magnetic core comprising dual core sections, each of the dual core sections having three openings; and
three winding phases comprising a plurality of windings made of a conductive material around the magnetic core through the openings and surrounded by an insulating layer having a dielectric constant that varies as a function of voltage.

21. The three-phase transformer of claim 21, wherein the dielectric constant of the insulating layer increases with voltage.

22. The three-phase transformer of claim 21, wherein the insulating layer is disposed between the plurality of windings.

23. The three-phase transformer of claim 21, wherein the insulating layer is disposed between a plurality of strands in each of the plurality of windings.

24. The three-phase transformer of claim 21, wherein the insulating layer is disposed at a plurality of corners of each of the plurality of windings.
